(19) United States
(12) Patent Application Publication
(10) Pub. No.: US 2021/0396186 A1
(43) Pub. Date: Dec. 23, 2021

(54) CONTROL ARRANGEMENT AND METHOD FOR CONTROLLING OPERATION OF AN INTERNAL COMBUSTION ENGINE

(71) Applicant: Scania CV AB, Södertälje (SE)

(72) Inventors: Erik HÖCKERDAL, Södertälje (SE); Anders LARSSON, Tullinge (SE)

(73) Assignee: Scania CV AB, Södertälje (SE)

(21) Appl. No.: 17/341,442

(22) Filed: Jun. 8, 2021

(30) Foreign Application Priority Data
Jun. 17, 2020 (SE) 2050728-1

(51) Int. Cl. F02D 13/02

(52) U.S. Cl. CPC F02D 13/0207; F02D 2200/1002

(57) ABSTRACT

The invention relates to a method of controlling a variable valve timing arrangement of an internal combustion engine, the variable valve timing arrangement being arranged to control the timing of an intake valve and an exhaust valve of the internal combustion engine, the method comprising: controlling the variable valve timing arrangement so as to delay the intake valve lifts and to advance the exhaust valve lifts in response to at least one parameter representative of a current load of the internal combustion engine passing a certain threshold value, thereby indicating that the internal combustion engine is operated in a low load state The invention relates also to a computer program product comprising program code for a computer for implementing a method according to the invention. The invention relates also to a control arrangement and a vehicle comprising the control arrangement.

### CROSS-REFERENCE TO RELATED APPLICATION

This application claims priority under 35 U.S.C. 119(a) to Swedish Patent Application No. 2050728-1 filed Jun. 17, 2020, the contents of which are also incorporated herein by reference.

### FIELD OF THE INVENTION

The present invention relates to a method for controlling a variable valve timing (VVT) arrangement of an internal combustion engine. The invention also relates to a control arrangement configured to control a VVT-arrangement of an internal combustion engine

### BACKGROUND OF THE INVENTION

Today vehicle engines having relatively high compression ratios tend to generate powerful vibrations, in particular when the engine is running at low engine speed, such as at idling. The vibrations may cause discomfort for an operator of the vehicle. The vibrations may also generate noise emissions which may be annoying for the operator as well as for people in a vicinity of the vehicle. Previously the issue regarding undesired vibrations has been dealt with by increasing the engine speed idle value. This however results in a higher engine fuel consumption and is not an optimal solution. In addition to increased fuel consumption a higher idle engine speed setting is causing increased idling friction as well as increased after treatment cooling requiring certain thermal management measures later on being associated with fuel costs.

### SUMMARY OF THE INVENTION

In light duty vehicles cam phasers have been used for emission control and fuel saving purposes for more than 20 years. For heavy duty vehicles however, the cam actuation technology has not been widely implemented until now. Cam phasers are one of the simplest technologies among the so called variable valve timing technologies and hence considered very cost efficient. The working principle of a cam phaser is to enable a phase shift of the intake and exhaust cam shafts in relation to the crank shaft, and hence the timing of the intake and exhaust valve opening and closings relative to the position of the piston. In this way the amount and property of the in cylinder trapped mass can be efficiently controlled.

It would be advantageous to achieve a method and a control arrangement overcoming, or at least alleviating, at least some of the above mentioned drawbacks. In particular, it would be desirable to enable a method and control arrangement reducing engine vibrations and noise emissions. To better address one or more of these concerns, a method and a control arrangement having the features defined in the independent claims are provided.

According to an aspect of the invention, a method of controlling a variable valve timing (VVT) arrangement of an internal combustion engine is provided. The variable valve timing arrangement is arranged to control the timing of an intake valve and an exhaust valve of the internal combustion engine. The method comprises:

controlling the variable valve timing arrangement so as to delay the intake valve lifts and to advance the exhaust valve lifts in response to at least one parameter representative of a current load of the internal combustion engine passing a certain threshold value, thereby indicating that the internal combustion engine is operated in a low load state.

With the present invention, cylinder peak pressures at TDC-fire CAD are reduced, and an additional cylinder peak pressure is introduced about TDC-gas exchange CAD. Herein TDC means Top Dead Centre. Herein CAD means Crank Angle Degrees. Peak valve lift positions of the engine cylinders are moved according to the proposed method. Hereby reduced levels of engine torque variations are achieved. This provides reduced vibration levels of the engine. Further, this provides reduced noise emissions when the engine is operated in a low load state. Vibrations of the engine are reduced when the internal combustion engine is operated in a low load state.

The low load state may comprise the states of idling, motoring and, in general, when the engine is running at a relatively low load. Hereby fuel consumption of the engine may be lowered over time, which may lower costs of operating the engine.

By reducing the level of engine vibrations reduced stress on engine components, such as sensor arrangements, actuators, etc. is achieved. In case the engine is provided for a vehicle, such as a heavy vehicle, other vehicle components will also be subjected to reduced stress impact. Further, the reduced noise emissions, results in a better working environment for an operator of the vehicle.

Lowered noise emissions generated during operation of the engine may qualify vehicle operation in so called silence zones in metropolitan areas, e.g. involving distribution of goods during night.

By a delayed intake valve closing the amount of trapped gas in the cylinder prior to compression is reduced which gives a significantly reduced peak cylinder pressure during the combustion. The delayed intake valve closing (and opening) is combined with an earlier opening and closing of the exhaust valves which causes more exhaust gases to be trapped in the cylinder than with un-phased valve events. These trapped exhaust gases are compressed during part of the exhaust stroke of the piston causing increased pressure in the cylinder.

These cylinder pressures translates via the piston and crank shaft to a flywheel, creating a pulsating/oscillating torque. For high compression ratios and few cylinders on the engine these oscillations cause discomfort and stress on the engine, vehicle and driver. By reducing the peak cylinder pressure during combustion and introducing a balancing cylinder pressure peak (even though this effect is smaller than the reduced combustion cylinder pressure) on the normal cylinder gas exchange period, a smoother operation of the engine is achieved.

According to an embodiment the low load state is when the internal combustion engine operates at load lower than 20% of maximum available load.

According to an embodiment the at least one parameter representative of a current load of the internal combustion engine comprises the current engine torque. According to an embodiment the certain threshold value is equal to or lower than 20% of a maximum available engine torque. The prevailing engine torque may be measured/determined with relatively high accuracy which thus results in a correct determination whether the internal combustion engine is operating in a low load state.

According to an embodiment the at least one parameter representative of a current load of the internal combustion engine comprises a current Lambda value (λ). According to an embodiment the certain threshold value is equal to or higher than 2.0. The Lambda-value may be measured/determined with relatively high accuracy which thus results in a correct determination whether the internal combustion engine is operated in a low load state.

According to an embodiment the method comprises the steps of:

controlling delaying of the intake valve lifts by 40-80 crank angle degrees; and

controlling advancing of the exhaust valve lifts by 40-80 crank angle degrees.

By rotating an intake camshaft of the internal combustion engine to a quite significant extent, e.g. of 50-60 crank angle degrees relative a reference angle, vibrations of the engine may be significantly reduced when the internal combustion engine is operated in a low load state. Hereby the intake valve lift position of the engine is delayed. By rotating an exhaust camshaft of the internal combustion engine to a quite significant extent, e.g. of (−50)-(−60) degrees relative a reference angle, vibrations of the engine may be significantly reduced when the predetermined operational state is at hand. Hereby the exhaust valve lift position of the engine is advanced.

According to an embodiment the method comprises the step of controlling delaying of the intake valve lifts and advancing of the exhaust valve lifts simultaneously and to the same extent. Hereby a balanced process of reducing cylinder peak pressures at TDC-fire and adding a second cylinder pressure peak at TDC-gas is achieved. The process is smooth in terms of not generating unnecessary vibrations of the engine. According to an example the advancing and delaying of valve lift positions are performed at the same rate.

According to an embodiment the method comprises the step of:

if the internal combustion engine is not any longer operated in the low load state, controlling the variable valve timing arrangement so as to advance the intake valve lifts and to delay the exhaust valve lifts according to settings of an ordinary operational state.

This ordinary operational state of the camshafts may correspond to an orientation of the intake camshaft and the exhaust camshaft of the engine being in line with reference angles thereof, i.e. no applied rotation by means of the cam phasers. The ordinary operational state may involve phase shifting of the camshafts to a certain extent, e.g. for allowing optimal fuel combustion efficiency.

According to another aspect of the present invention, a control arrangement is provided. The control arrangement is configured to control a variable valve timing (VVT) arrangement of an internal combustion engine, the variable valve timing arrangement being arranged to control the timing of an intake valve and an exhaust valve of the internal combustion engine. The control arrangement is configured to perform the method according to the previously described aspect.

It will be appreciated that all the embodiments described for the method aspect are applicable also to the control arrangement.

According to an aspect of the invention there is provided a vehicle comprising a control arrangement according to what is disclosed herein. The vehicle may be a truck.

According to an aspect of the invention there is provided a computer program product comprising instructions which, when the program is executed by a computer, cause the computer to carry out the method according to any one of the embodiments depicted herein.

According to an aspect of the invention there is provided a computer-readable storage medium comprising instructions which, when executed by a computer, cause the computer to carry out the method according to any one of the embodiments depicted herein.

It will be appreciated that the computer program product and the computer-readable storage medium may be comprised in the control arrangement.

Further objects, advantages and novel features of the present invention will become apparent to one skilled in the art from the following details, and also by putting the invention into practice. Whereas the invention is described below, it should be noted that it is not confined to the specific details described. One skilled in the art having access to the teachings herein will recognize further applications, modifications and incorporations in other fields, which are within the scope of the invention.

### BRIEF DESCRIPTION OF THE DRAWINGS

For fuller understanding of embodiments of the present invention and its further objects and advantages, the detailed description set out below should be read in conjunction with the accompanying drawings, in which the same reference notations denote similar items in the various diagrams, and in which:

FIG. 1 schematically illustrates a vehicle according to an embodiment of the invention;

FIG. 2a schematically illustrates a system according to an embodiment of the invention;

FIG. 2b schematically illustrates an engine arrangement according to an embodiment of the invention;

FIG. 3a schematically illustrates a diagram according to an embodiment of the invention;

FIG. 3b schematically illustrates two diagrams according to an embodiment of the invention;

FIG. 4 is a schematic flowchart of a method according to an embodiment of the invention; and

FIG. 5 schematically illustrates a computer according to an embodiment of the invention.

### DETAILED DESCRIPTION

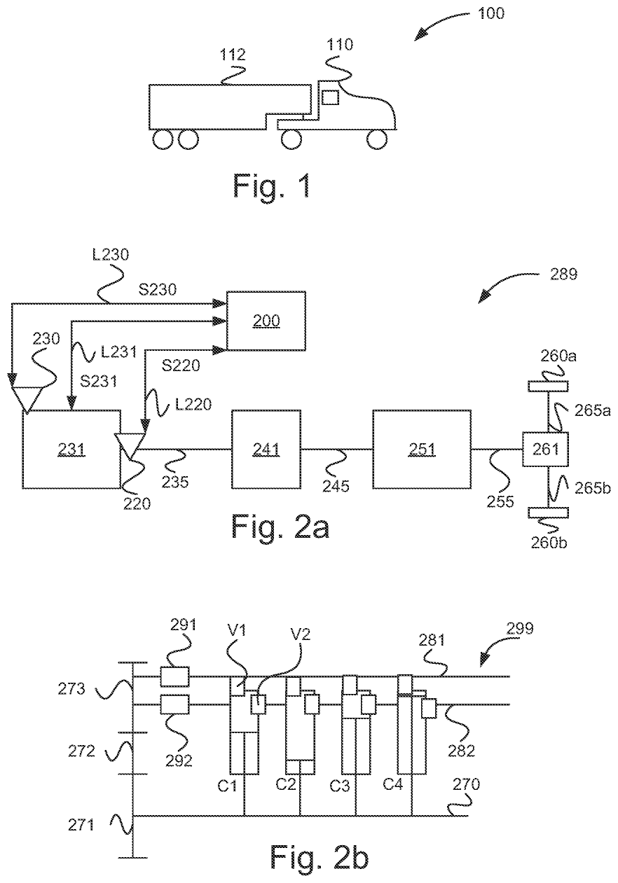

FIG. 1 depicts a side view of a vehicle 100. The exemplified vehicle 100 comprises a tractor unit 110 and a trailer 112. The vehicle 100 may be a heavy vehicle, e.g. a truck or a bus. It may alternatively be a car.

The proposed method and the proposed control arrangement are applicable to various vehicles comprising a variable valve timing (VVT) arrangement of an internal combustion engine. The vehicle may be a mining machine, tractor, dumper, wheel-loader, forest machine, earth mover, road construction vehicle, road planner, emergency vehicle or a tracked vehicle.

The proposed method and the proposed control arrangement are according to one aspect of the disclosure well suited to other platforms which comprise a variable valve timing (VVT) arrangement of an internal combustion engine than motor vehicles, e.g. watercraft. The watercraft may be of any kind, e.g. motorboats, steamers, ferries or ships.

The term “link” refers herein to a communication link which may be a physical connection such as an opto-electronic communication line, or a non-physical connection such as a wireless connection, e.g. a radio link or microwave link.

The term “control arrangement” is according to one embodiment herein defined as an arrangement comprising only one electronic control arrangement or a number of connected electronic control arrangements. Said one electronic control arrangement or said number of connected electronic control arrangements may be arranged to perform the steps according to the method depicted herein.

The terminology used herein is for the purpose of describing particular aspects of the disclosure only, and is not intended to limit the disclosure. As used herein, the singular forms “a”, “an” and “the” are intended to include the plural forms as well, unless the context clearly indicates otherwise.

In some implementations and according to some aspects of the disclosure, the functions or steps noted in the blocks can occur out of the order noted in the operational illustrations. For example, two blocks shown in succession can in fact be executed substantially concurrently or the blocks can sometimes be executed in the reverse order, depending upon the functionality/acts involved. Also, the functions or steps noted in the blocks can according to some aspects of the disclosure be executed continuously in a loop.

It should be emphasized that the term “comprises/comprising” when used in this specification is taken to specify the presence of stated features, integers, steps, or components, but does not preclude the presence or addition of one or more other features, integers, steps, components, or groups thereof.

FIG. 2a schematically illustrates a system 289 of the vehicle 100. The system 289 is situated in the tractor unit 110 and comprises an engine 231 with an output shaft 235, which is connected to a clutch arrangement 241.

The engine 231 may be any suitable engine, such as an internal combustion engine comprising a so called Otto-engine or a diesel engine. The engine 231 may comprise any suitable cylinder configuration. The engine 231 may be any engine/motor/propulsion arrangement having a number of engine cylinders for combustion, an intake camshaft and an exhaust camshaft, the camshafts being independently controllable by a respective cam phaser. The engine 231 may be any engine/motor/propulsion arrangement having a variable valve timing (VVT) arrangement.

The clutch arrangement 241 may be an automated clutch arrangement. This clutch arrangement 241 is also connected to a shaft 245 which is an input shaft to a gearbox 251.

The clutch arrangement 241 may be anyone of the group of clutch arrangements comprising a dry friction clutch, wet friction clutch, electric clutch and hydraulic converter. According to one embodiment the transmission of the vehicle 100 is not provided with a clutch arrangement.

The gearbox 251 may be a hydraulic automatic transmission, an automated manual transmission (AMT), a dual input shaft transmission or other multiple gear transmission which are controlled by a control arrangement.

The gearbox 251 may be configured to comprise any suitable number of gear steps, e.g. 5, 12 or 16. The gearbox 251 has an output shaft 255 to transmit torque to at least one pair of tractive wheels comprising a first tractive wheel 260a and a second tractive wheel 260b via an auxiliary gearbox 261 and a shaft 265a and 265b, respectively.

The engine 231 is arranged to generate torque which can be transmitted to said tractive wheels 260a and 260b so as to propel the vehicle 100. Said torque is hereby transmitted via a transmission arrangement of the vehicle 100 comprising the shaft 235, the clutch arrangement 241, the shaft 245, the gearbox 251, the shaft 255, the auxiliary gearbox 261 and the shafts 265a and 265b.

A control arrangement 200 is arranged for communication with said engine 231 via a link L231 and is adapted for controlling the operation of said engine 231 in accordance with stored control routines. The control arrangement 200 is arranged to control the engine 231 by means of control signals S231 comprising engine operation control commands. One such command may relate to controlling an intake camshaft cam phaser so as to rotate an intake camshaft to a certain extent and controlling an exhaust camshaft cam phaser so as to rotate an exhaust camshaft to a certain extent. One such command may relate to controlling a variable valve timing arrangement so as to delay intake valve lifts and to advance exhaust valve lifts in response to at least one parameter representative of a current load of the internal combustion engine passing a certain threshold value, thereby indicating that the internal combustion engine is operated in a low load state.

An engine speed sensor 220 is arranged to continuously determine a prevailing engine speed N of the engine 231. The engine speed sensor 220 may be provided at the shaft 235. The engine speed sensor 220 is adapted to continuously or intermittently send signals S220 which contain information about said determined prevailing engine speed N to the control arrangement 200 via said link L220. The control arrangement 200 is adapted to continuously receive said signals S220 and storing the information in a memory therein. The engine speed sensor 220 may alternatively be situated in any other suitable position for determining a prevailing engine speed N of said engine 231, such as at a fly-wheel (see FIG. 2b) of said engine 231.

The control arrangement 200 is arranged for communication with a Lambda-sensor configuration 230 via a link L230. The Lambda-sensor configuration 230 is arranged to continuously determine adequate information for determining a prevailing Lambda-value λ relating to engine operation. Here the Lambda-sensor configuration 230 is arranged in an outlet passage of the engine 231. The Lambda-sensor configuration 230 is arranged to send signals S230 comprising the thus determined adequate information for determining the prevailing Lambda-value λ to the control arrangement 200 via the link L230. The Lambda-value λ is known to relate to an Air Fuel Ratio (AFR). According to one embodiment the Lambda-value λ is calculated/estimated on the basis of quantities such as air and fuel flow that can be estimated or measured.

The control arrangement 200 is arranged to (preferably continuously) determine a prevailing requested load of the engine 231. The load may be requested by an operator of the vehicle 100, e.g. by means of an accelerator. The load may alternatively be requested by any engine controlling function of the control arrangement 200. The control arrangement 200 is arranged to (preferably continuously) determine a prevailing engine speed N, e.g. on the basis of the received signals S220.

The control arrangement 200 may comprise a number of control units and method steps depicted herein may be performed by a number of different control units and/or cloud based.

FIG. 2b schematically illustrates an engine arrangement 299 according to an embodiment of the invention.

The engine arrangement 299 comprises four engine cylinders C1-C4. A crank shaft 270 is arranged to drive a fly-wheel 271, which in turn is arranged to drive an intermediate gear transmission arrangement 272. The intermediate gear transmission arrangement 272 is arranged to drive a camshaft gear transmission arrangement 273.

The camshaft gear transmission arrangement 273 is arranged to drive an intake camshaft 281. The intake camshaft 281 is arranged to operate at least one intake valve configuration V1 of each of the engine cylinders C1-C4. Herein the notation V1 is only indicated for the first cylinder C1. A first cam phaser 291 is arranged at the intake camshaft 281. The first cam phaser 291 may also be denoted intake camshaft cam phaser. The first cam phaser 291 may be an electrical cam phaser. The first cam phaser 291 may be a hydraulic cam phaser. The control arrangement 200 is arranged to control operation of the first cam phaser 291. The first cam phaser 291 is arranged to rotate the intake camshaft 281 about its own axis. According to one embodiment the first cam phaser 291 is arranged to rotate the intake camshaft 281 about its own axis 0-90 degrees. According to one embodiment the first cam phaser 291 is arranged to rotate the intake camshaft 281 to an extent defined by the interval 40-80 degrees relative a reference angle α01 when the engine 231 is operated in a low load state, e.g. when the engine 231 operates at load lower than 20% of maximum available load. The reference angle α01 is set to 0 degrees. The reference angle α01 relates to an ordinary unaffected operational state of the intake camshaft 281.

The camshaft gear transmission arrangement 273 is arranged to drive an exhaust camshaft 282. The exhaust camshaft 282 is arranged to operate at least one exhaust valve configuration V2 of each of the engine cylinders C1-C4. Herein only the notation V2 is only indicated for the first cylinder C1. A second cam phaser 292 is arranged at the exhaust camshaft 282. The second cam phaser 292 may also be denoted exhaust camshaft cam phaser. The second cam phaser 292 may be an electrical cam phaser. The second cam phaser 292 may be a hydraulic cam phaser. The control arrangement 200 is arranged to control operation of the second cam phaser 292. The second cam phaser 292 is arranged to rotate the exhaust camshaft 282 about its own axis. According to one embodiment the second cam phaser 292 is arranged to rotate the exhaust camshaft 282 about its own axis 0-90 degrees. According to one embodiment the second cam phaser 292 is arranged to rotate the exhaust camshaft 282 to an extent defined by the interval 40-80 degrees relative a reference angle α02 when the engine 231 is operated in a low load state, e.g. when the engine 231 operates at load lower than 20% of maximum available load. The reference angle α02 is set to 0 degrees. The reference angle α02 relates to an ordinary unaffected operational state of the intake camshaft 281.

The first cam phaser 291 and the second cam phaser 292 are arranged to control the respective cam shaft independently. The first cam phaser 291 and the second cam phaser 292 are arranged to control the respective cam shaft simultaneously and to the same extent.

According to one example the intake camshaft 281 and the exhaust camshaft 282 are arranged in a coaxial manner. According to one example the intake camshaft 281 and the exhaust camshaft 282 are arranged as a “shaft-in-shaft”-configuration.

According to one embodiment only one cam phaser is provided. The single cam phaser may be arranged to control the rotation of both the intake camshaft and the exhaust camshaft. The single cam phaser is according to an embodiment incorporated with a set comprising the fly-wheel 271, the intermediate gear transmission arrangement 272 and the camshaft gear transmission arrangement 273. The single cam phaser may be arranged to control rotation of the intake camshaft 281 and the exhaust camshaft 282 in a symmetrical manner.

According to one embodiment the intake camshaft and the exhaust camshaft are integrally configured. According to one embodiment the intake camshaft is housing the exhaust camshaft. According to one embodiment the exhaust camshaft is housing the intake camshaft. According to one embodiment the integrally configured camshafts are independently controlled.

The control arrangement 200 is configured to control a variable valve timing (VVT) arrangement of engine 231, the variable valve timing arrangement being arranged to control the timing of an intake valve and an exhaust valve of the engine 231 according to the disclosure herein.

According to an embodiment the control arrangement 200 is arranged for controlling delaying of intake valve lifts to 40-80 crank angle degrees. According to an embodiment the control arrangement 200 is arranged for controlling the rotation of the intake camshaft 281 to correspond to delaying the intake valve lifts of 40-80 crank angle degrees when the engine 231 is operated in a low load state.

According to an embodiment the control arrangement 200 is arranged for controlling advancing of the exhaust valve lifts to 40-80 crank angle degrees. According to an embodiment the control arrangement 200 is arranged for controlling the rotation of the exhaust camshaft 282 to correspond to advancing the exhaust valve lifts of 40-80 crank angle degrees when the engine 231 is operated in a low load state.

According to an embodiment the control arrangement 200 is arranged for controlling delaying of the intake valve lifts and advancing of the exhaust valve lifts simultaneously and to the same extent.

According to an embodiment the control arrangement 200 is arranged for, if the engine 231 is not any longer operated in a low load state, controlling the variable valve timing arrangement so as to advance the intake valve lifts and to delay the exhaust valve lifts according to settings of an ordinary operational state (α01; α02).

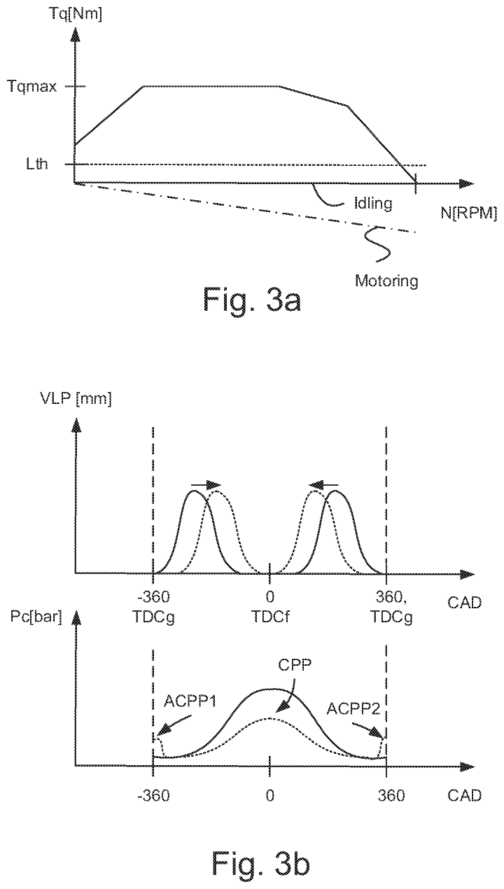

FIG. 3a schematically illustrates a diagram wherein a maximum engine torque Tq is given as a function of engine speed N. Engine torque is hereby given in Newton meter [Nm] and engine speed in revolutions per minute RPM. Herein the engine torque refers to the torque at the first shaft 235.

According to an example a load threshold value Lth is illustrated in the diagram. According to this example the load threshold value Lth is 20% of a maximum load Tq max. Herein a low load state of the engine 231 is defined as a load point of the engine 231 being below the load threshold value Lth. A lowest load point of the engine at a given engine speed N is defined by the line indicating a motoring state of the engine 231. The load threshold value Lth may according to one example be 5% of the maximum load Tq max. The load threshold value Lth may according to one example be 10% of the maximum load Tq max. The load threshold value Lth may according to one example be 15% of the maximum load Tq max.

The states of idling and motoring are part of the low load state of the engine 231 for which the cam phasers are operated according to the disclosure herein. The states of idling and motoring are part of the low load state of the engine 231 for which the variable valve timing arrangement is operated according to the disclosure herein.

According to one example the load threshold value Lth is a function of engine speed N. Hereby the load threshold value may vary on the basis of a prevailing engine speed N.

Naturally other forms of the engine torque curve are possible. The curve exemplified with reference to FIG. 3a is a simplified version.

FIG. 3b schematically illustrates two diagrams wherein a valve lift position VLP (mm) is presented as a function of crank angle degrees CAD and wherein cylinder pressure Pc (bar) is presented as a function of crank angle degrees CAD. TDCf refers to Top Dead Centre fire (0 CAD). TDCg refers to Top Dead Centre gas exchange (−360 CAD and 360 CAD). The valve lift position is associated with the engine cylinders C1-C4 of the engine 231.

Herein, curves relating to a normal mode is illustrated by a solid line. The normal mode corresponds to that the engine 231 is not operating in a low load state according to the disclosure herein. Hereby the intake camshaft 281 and the exhaust camshaft 282 may not be rotated by means of the intake camshaft cam phaser 291 and the exhaust camshaft cam phaser 292 or rotated to only a certain, relatively low, extent. A certain, relatively low, extent herein means lower than e.g. +/−40 CAD relative a reference degree α01, α02.

Herein curves relating to a low vibration mode is illustrated by a broken line. The low vibration mode corresponds to that the engine 231 is operating in a low load state according to the disclosure herein. Hereby the intake camshaft 281 and the exhaust camshaft 282 have been rotated to a certain extent, e.g. +/−60 degrees relative reference angles α01, α02, by means of the intake camshaft cam phaser 291 and the exhaust camshaft cam phaser 292. Arrows are schematically indicating respective phase shifts and a difference between operation of the camshafts when the engine is not operating in a low load state and when the engine is operating in a low load state.

As illustrated, a cylinder peak pressure CPP has been reduced in case the engine is operated in a low load state. In particular, additional cylinder peak pressures ACPP1 and ACPP2 appear at about −360 CADg and 360 CADg.

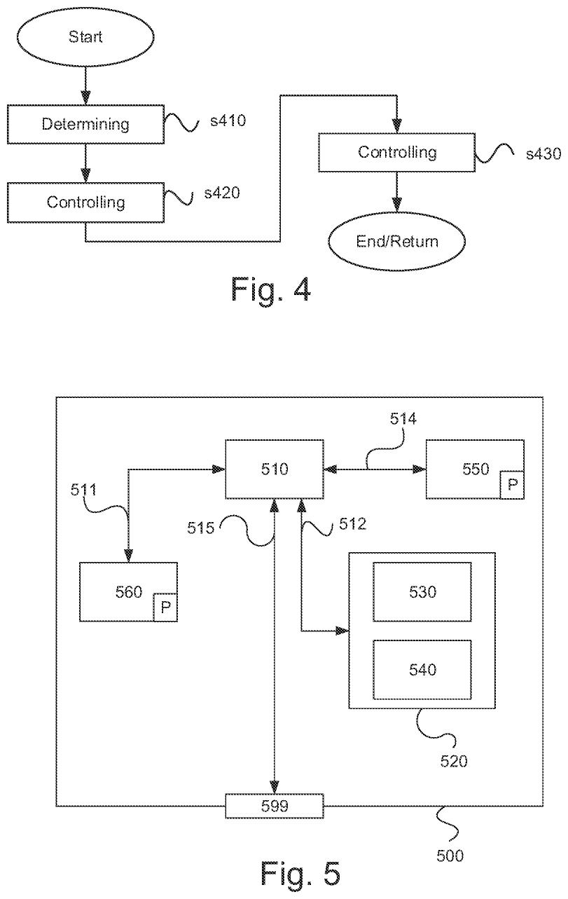

FIG. 4 schematically illustrates a flow chart of a method of controlling a variable valve timing (VVT) arrangement of an internal combustion engine 231, the variable valve timing arrangement being arranged to control the timing of an intake valve and an exhaust valve of the internal combustion engine.

According to a method step s410 it is determined if the engine 231 is operating in a low load state. The low load state involves relatively low engine loads. The low load state may comprise the state of idling. The low load state may comprise the state of motoring.

According to one example the low load state is when the internal combustion engine 231 operates at load lower than 20% of maximum available load.

According to a method step s420 the variable valve timing arrangement is controlled so as to delay the intake valve lifts and to advance the exhaust valve lifts in response to at least one parameter representative of a current load of the internal combustion engine passing a certain threshold value, thereby indicating that the internal combustion engine is operated in a low load state. According to one example the low load state is when the internal combustion engine operates at load lower than 20% of maximum available load.

The at least one parameter may comprise the current engine torque L. According to an example the certain threshold value Lth is equal to or lower than 20% of a maximum available engine torque.

The at least one parameter may comprise a current Lambda value (λ). According to an example the certain threshold value Xth is equal to or higher than 2.0. According to an example the certain threshold value Xth is within an interval of 1.8-2.2.

Hereby rotation of an intake camshaft 281 is controlled to correspond to delaying intake valve lifts of 40-80 crank angle degrees. Hereby rotation of an exhaust camshaft 282 is controlled to correspond to advancing exhaust valve lifts of 40-80 crank angle degrees.

The rotation of the respective camshafts may be performed simultaneously and to the same extent.

Hereby engine cylinder peak pressures (CCP) at TDCf are reduced, an additional engine cylinder peak pressure (ACPP) about TDCg is introduced and valve lift positions CAD are changed (see FIG. 3b).

If the internal combustion engine is not any longer operated in the low load state, the variable valve timing arrangement is controlled (according to method step s430) so as to advance the intake valve lifts and to delay the exhaust valve lifts according to settings of an ordinary operational state (α01; α02).

After the method step s430 the method ends/is returned.

FIG. 5 is a diagram of one version of a device 500. The control arrangement 200 described with reference to FIG. 2a may in one version comprise the device 500. The device 500 comprises a non-volatile memory 520, a data processing unit 510 and a read/write memory 550. The non-volatile memory 520 has a first memory element 530 in which a computer program, e.g. an operating system, is stored for controlling the function of the device 500. The device 500 further comprises a bus controller, a serial communication port, I/O means, an A/D converter, a time and date input and transfer unit, an event counter and an interruption controller (not depicted). The non-volatile memory 520 has also a second memory element 540.

The computer program P may comprise routines for determining if the engine 231 is operating in a low load state. The computer program P may comprise routines for determining if the engine 231 is no longer operating in a low load state.

The computer program P may comprise routines for controlling the variable valve timing arrangement so as to delay the intake valve lifts and to advance the exhaust valve lifts in response to at least one parameter representative of a current load of the internal combustion engine passing a certain threshold value, thereby indicating that the internal combustion engine is operated in a low load state.

The computer program P may comprise routines for performing any of the process steps detailed with reference to the disclosure.

The program P may be stored in an executable form or in compressed form in a memory 560 and/or in a read/write memory 550.

Where it is stated that the data processing unit 510 performs a certain function, it means that it conducts a certain part of the program which is stored in the memory 560 or a certain part of the program which is stored in the read/write memory 550.

The data processing device 510 can communicate with a data port 599 via a data bus 515. The non-volatile memory 520 is intended for communication with the data processing unit 510 via a data bus 512. The separate memory 560 is intended to communicate with the data processing unit via a data bus 511. The read/write memory 550 is arranged to communicate with the data processing unit 510 via a data bus 514. The links L220, L230 and L231, for example, may be connected to the data port 599 (see FIG. 2a).

When data are received on the data port 599, they are stored temporarily in the second memory element 540. When input data received have been temporarily stored, the data processing unit 510 will be prepared to conduct code execution as described above.

Parts of the methods herein described may be conducted by the device 500 by means of the data processing unit 510 which runs the program stored in the memory 560 or the read/write memory 550. When the device 500 runs the program, method steps and process steps herein described are executed.

The foregoing description of the preferred embodiments of the present invention is provided for illustrative and descriptive purposes. It is not intended to be exhaustive, nor to limit the invention to the variants described. Many modifications and variations will obviously suggest themselves to one skilled in the art. The embodiments have been chosen and described in order to best explain the principles of the invention and their practical applications and thereby make it possible for one skilled in the art to understand the invention for different embodiments and with the various modifications appropriate to the intended use.

1. A method of controlling a variable valve timing arrangement of an internal combustion engine, the variable valve timing arrangement being arranged to control timing of an intake valve and an exhaust valve of the internal combustion engine, the method comprising:
controlling the variable valve timing arrangement so as to delay intake valve lifts and to advance exhaust valve lifts in response to at least one parameter representative of a current load of the internal combustion engine passing a certain threshold value, thereby indicating that the internal combustion engine is operated in a low load state.

2. The method according to claim 1, wherein the low load state is when the internal combustion engine operates at load lower than 20% of maximum available load.

3. The method according to claim 1, wherein the at least one parameter comprises the current engine torque.

4. The method according to claim 3, wherein the certain threshold value is equal to or lower than 20% of a maximum available engine torque.

5. The method according to claim 1, wherein the at least one parameter comprises a current Lambda value.

6. The method according to claim 5, wherein the certain threshold value is equal to or higher than 2.0.

7. The method according to claim 1, further comprising:
controlling delaying of the intake valve lifts by 40-80 crank angle degrees; and
controlling advancing of the exhaust valve lifts by 40-80 crank angle degrees.

8. The method according to claim 7, comprising the step of:
controlling delaying of the intake valve lifts and advancing of the exhaust valve lifts simultaneously and to the same extent.

9. The method according to claim 1, further comprising:
if the internal combustion engine is not any longer operated in the low load state, controlling the variable valve timing arrangement so as to advance the intake valve lifts and to delay the exhaust valve lifts according to settings of an ordinary operational state.

10. Control arrangement configured to control a variable valve timing arrangement of an internal combustion engine, the variable valve timing arrangement being arranged to control timing of an intake valve and an exhaust valve of the internal combustion engine, the control arrangement comprising one or more control units configured to control the variable valve timing arrangement so as to delay intake valve lifts and to advance exhaust valve lifts in response to at least one parameter representative of a current load of the internal combustion engine passing a certain threshold value, thereby indicating that the internal combustion engine is operated in a low load state.

11. A vehicle comprising a control arrangement configured to control a variable valve timing arrangement of an internal combustion engine, the variable valve timing arrangement being arranged to control timing of an intake valve and an exhaust valve of the internal combustion engine, the control arrangement comprising one or more control units configured to control the variable valve timing arrangement so as to delay intake valve lifts and to advance exhaust valve lifts in response to at least one parameter representative of a current load of the internal combustion engine passing a certain threshold value, thereby indicating that the internal combustion engine is operated in a low load state.

12. A computer program product comprising computer program code stored on a non-transitory computer-readable medium, said computer program product configured to control a variable valve timing arrangement of an internal combustion engine, the variable valve timing arrangement being arranged to control timing of an intake valve and an exhaust valve of the internal combustion engine, said computer program code comprising computer instructions to cause one or more control units to perform the following operations:
controlling the variable valve timing arrangement so as to delay intake valve lifts and to advance exhaust valve lifts in response to at least one parameter representative of a current load of the internal combustion engine passing a certain threshold value, thereby indicating that the internal combustion engine is operated in a low load state.

13. (canceled)

14. The control arranged according to claim 10 further comprising computer program code stored on a non-transitory computer-readable medium comprising computer instructions to cause the one or more control units to perform the recited controlling operation of the variable valve timing arrangement.

15. The vehicle according to claim 11, wherein the control arranged further comprises computer program code stored on a non-transitory computer-readable medium comprising computer instructions to cause the one or more control units to perform the recited controlling operation of the variable valve timing arrangement.
